(19) United States
(12) Patent Application Publication
(10) Pub. No.: US 2004/0210372 A1
(43) Pub. Date: Oct. 21, 2004

(54) Method and system of analyzing a powertrain

(76) Inventor: Alan R. Coutant, Peoria, IL (US)

Correspondence Address: CATERPILLAR INC., 100 N.E. ADAMS STREET, PATENT DEPT., PEORIA, IL, 616296490

(21) Appl. No.: 10/744,311

(22) Filed: Dec. 22, 2003

Related U.S. Application Data
(60) Provisional application No. 60/436,356, filed on Dec. 23, 2002.

(51) Int. Cl. G06F 17/00

(52) U.S. Cl. 701/51; 701/1

(57) ABSTRACT

The present invention includes a method and system configured to analyze a powertrain having a plurality of gear members. The method includes the step of establishing a powertrain characteristic associated with the gear members, establishing a mechanism associated with the powertrain characteristic, and analyzing the mechanism in response to the powertrain characteristic

This application claims the benefit of prior provisional patent application Serial No. 60/436,356, filed Dec. 23, 2002.

### TECHNICAL FIELD

This invention relates generally to a method and system of analyzing a powertrain, and more particularly, to a method and system configured to analyze a powertrain having a plurality of gear members.

### BACKGROUND

Designing a powertrain is a difficult and time-consuming task. There are generally many different configurations that may meet the general design guidelines, but with largely varying degrees of effectiveness. The ability to configure and review potential configurations quickly becomes unwieldy as the number of potential configurations grows. In configurations having multiple planetary gear sets it is difficult to understand the interaction of the gears. In addition, it is difficult to compare potential mechanisms with each other with respect to e-values and connection complexity. Therefore, many times the powertrain selected for implementation is not the best powertrain for the job. Therefore, despite the high level of effort spent designing a powertrain, the ultimate selection may be a more expensive and less effective solution than could have been obtained.

The present invention is directed to overcoming one or more of the problems set forth above.

### SUMMARY OF THE INVENTION

In one aspect of the present invention, a computer-based method of analyzing a powertrain having a plurality of gear elements is disclosed. The method includes the steps of establishing a powertrain characteristic associated with the gear elements, establishing a mechanism associated with the powertrain characteristic and analyzing the mechanism in response to the powertrain characteristic.

In another aspect of the present invention, a system configured to analyzing a powertrain having a plurality of gear elements is disclosed. The system includes a user interface configured to receive a plurality of powertrain characteristics associated with the gear elements, and graphically display at least one of a powertrain mechanism and a powertrain hook-up, and a controller configured to establish a mechanism associated with said powertrain characteristic, and analyze the mechanism in response to the powertrain characteristic.

### BRIEF DESCRIPTION OF THE DRAWINGS

FIG. 1 is an illustration of one embodiment of the elements of a powertrain;

FIG. 2 is an illustration an exemplary schematic representation of the gear elements;

FIG. 3 illustrates one embodiment of a system configured to analyze a powertrain having a plurality of gear elements;

FIG. 4 illustrates one embodiment of a method of analyzing a powertrain having a plurality of gear elements;

FIG. 5 illustrates one embodiment of a display associated with a user interface that will enable the user to graphically establish a mechanism;

FIG. 6 illustrates one embodiment of a graphical representation of the gear mechanism;

FIG. 7 illustrates one embodiment of a graphical representation of the gear mechanism;

FIG. 8 illustrates one embodiment of a sketch tool;

FIG. 9 illustrates a graphical interaction of gear elements;

FIG. 10 illustrates a plurality of gear member configurations that may be graphically represented and analyzed;

FIG. 11 illustrates a graphical representation of a two speed mechanism;

FIG. 12 illustrates one embodiment of a table that may be used to establish the number of planetary gear sets possible based on the number of members being used;

FIG. 13 illustrates one embodiment of a mechanism, and potential element assignments;

FIG. 14 illustrates one embodiment of a schematic illustration of a mechanism;

FIG. 15 illustrates one embodiment of an schematic illustration of an inversion of a mechanism;

FIG. 16 illustrates one embodiment of an schematic illustration of an inversion of a mechanism;

FIG. 17 illustrates one embodiment of a collision table;

FIG. 18 illustrates multiple schematics of varying connection complexity;

FIG. 19 illustrates one example of a redundant hookup;

FIG. 20 illustrates one embodiment of a user interface configured to display a hookup to the user;

FIG. 21 illustrates an exemplary graph of torque versus speed for a transmission;

FIG. 22 illustrates one embodiment of multiple user interfaces associated with the present disclosure; and

FIG. 23 illustrates on embodiment of a powertrain characteristic input interface.

### DETAILED DESCRIPTION

The present disclosure is associated with a computer based method and system associated with analyzing a powertrain having a plurality of gear elements. The method includes the steps of establishing a powertrain characteristic associated with the gear elements, establishing a mechanism associated with the powertrain characteristic, and analyzing the mechanism in response to the powertrain characteristic. In one embodiment, a gear element may be a sun gear, planetary gear, carrier, ring gear, or other type of gear associated with a powertrain. A planetary gear set may be described as a gear set having a sun, carrier, and ring gear. A mechanism may refer to the configuration of one or more gear sets.

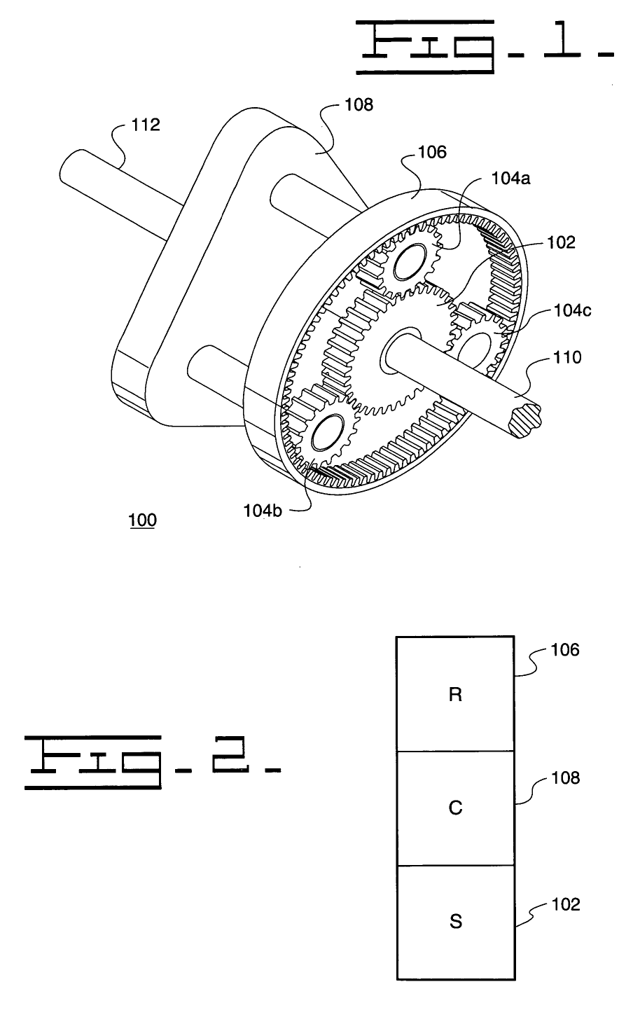

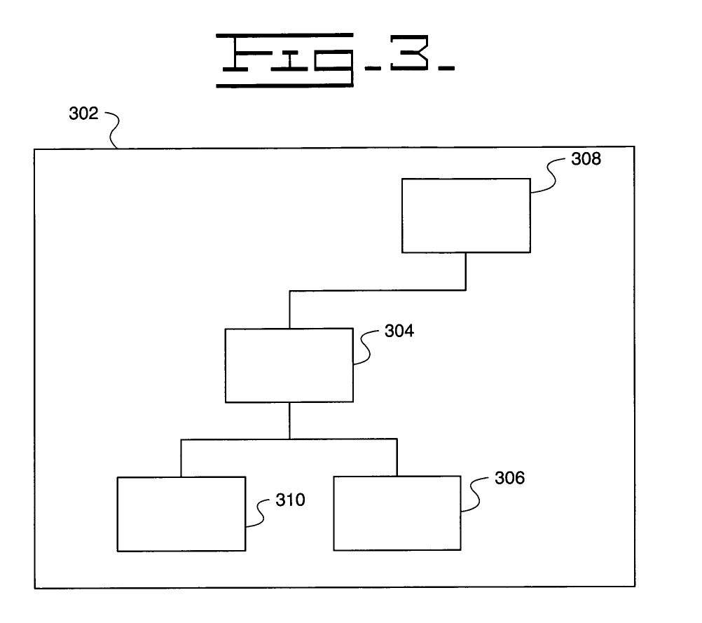

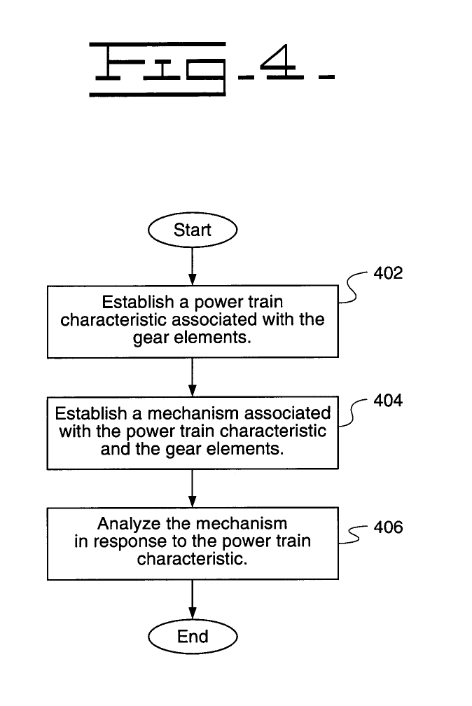

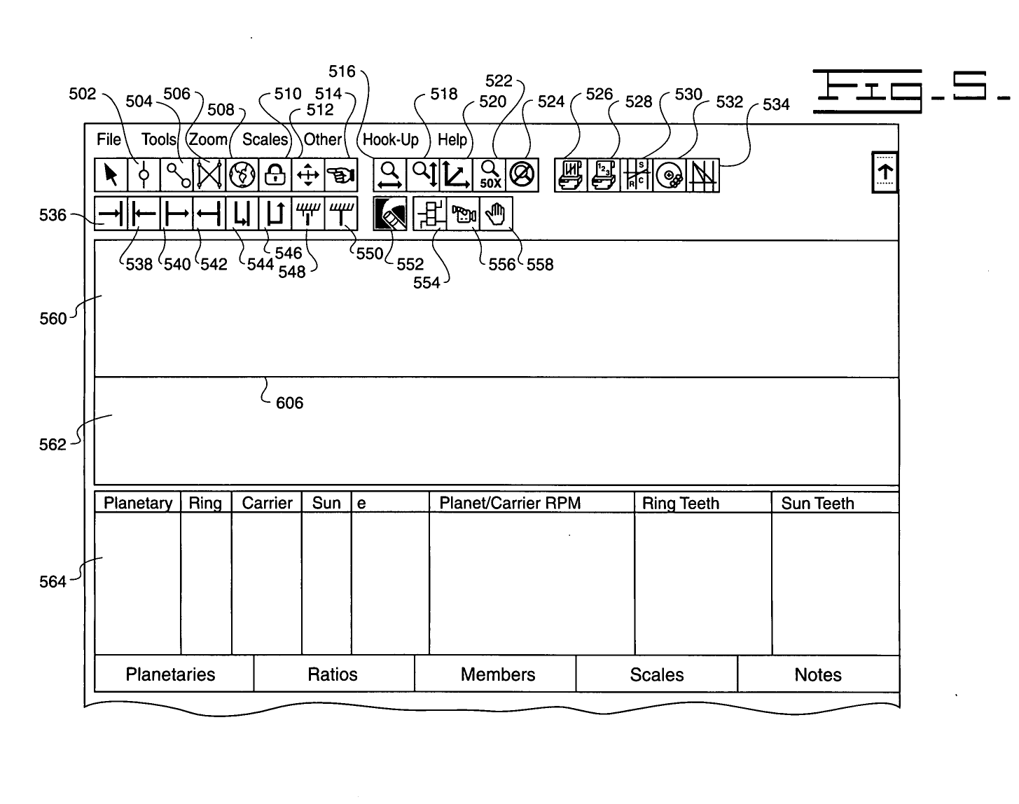

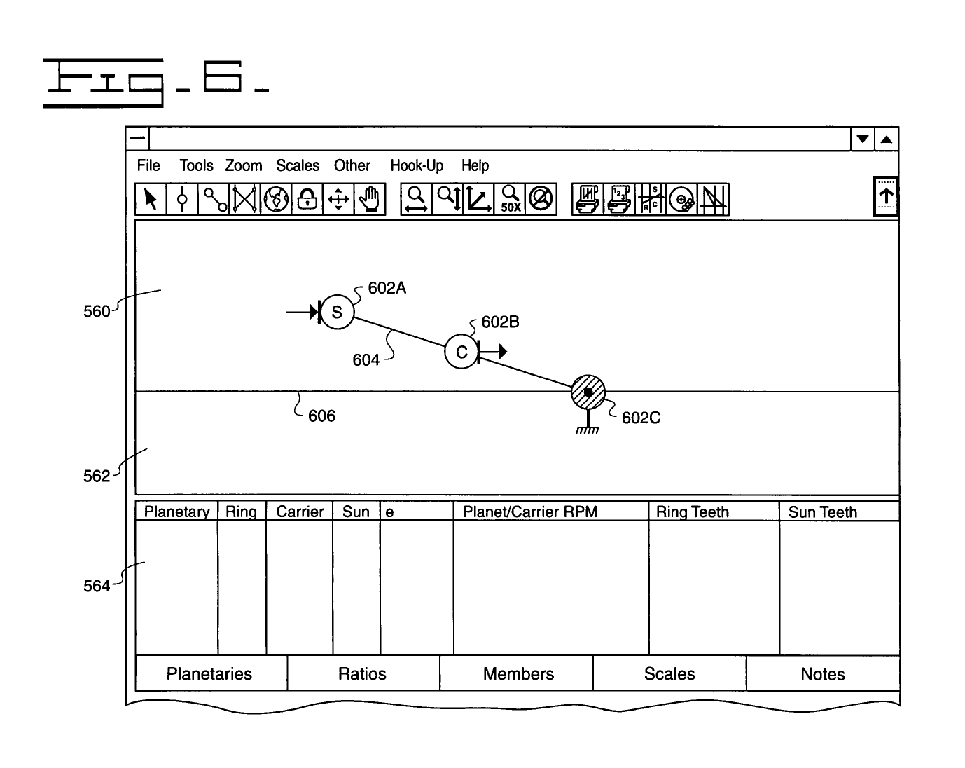

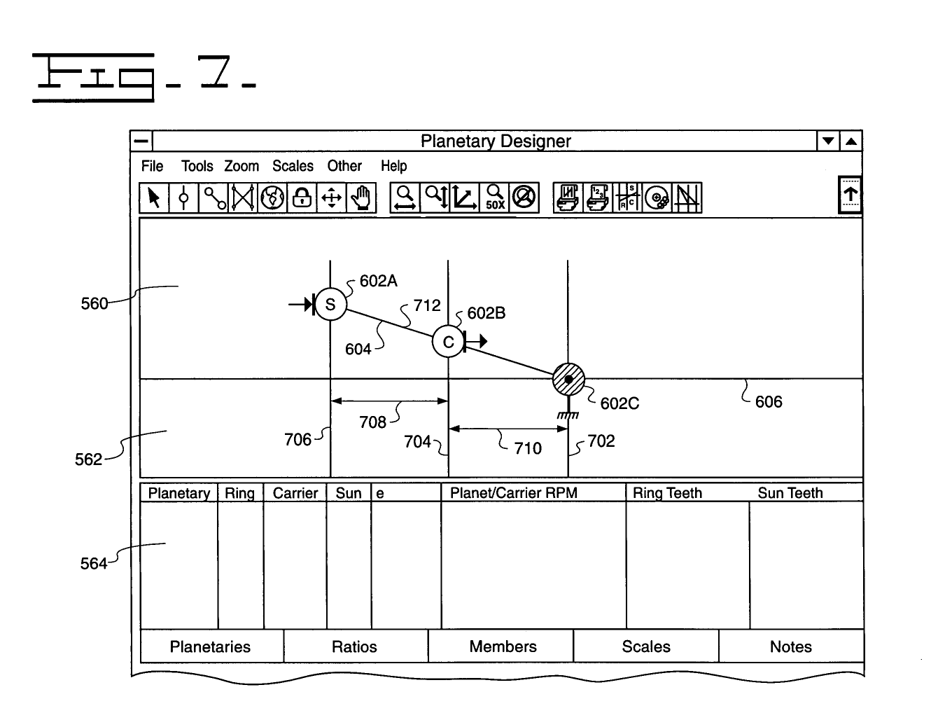

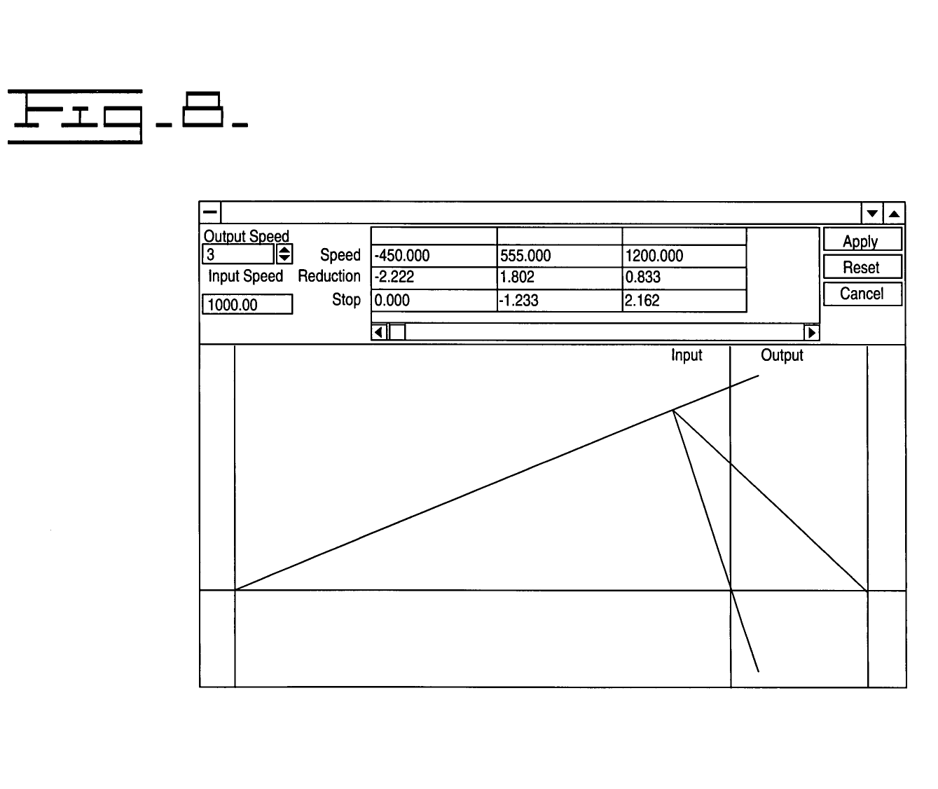

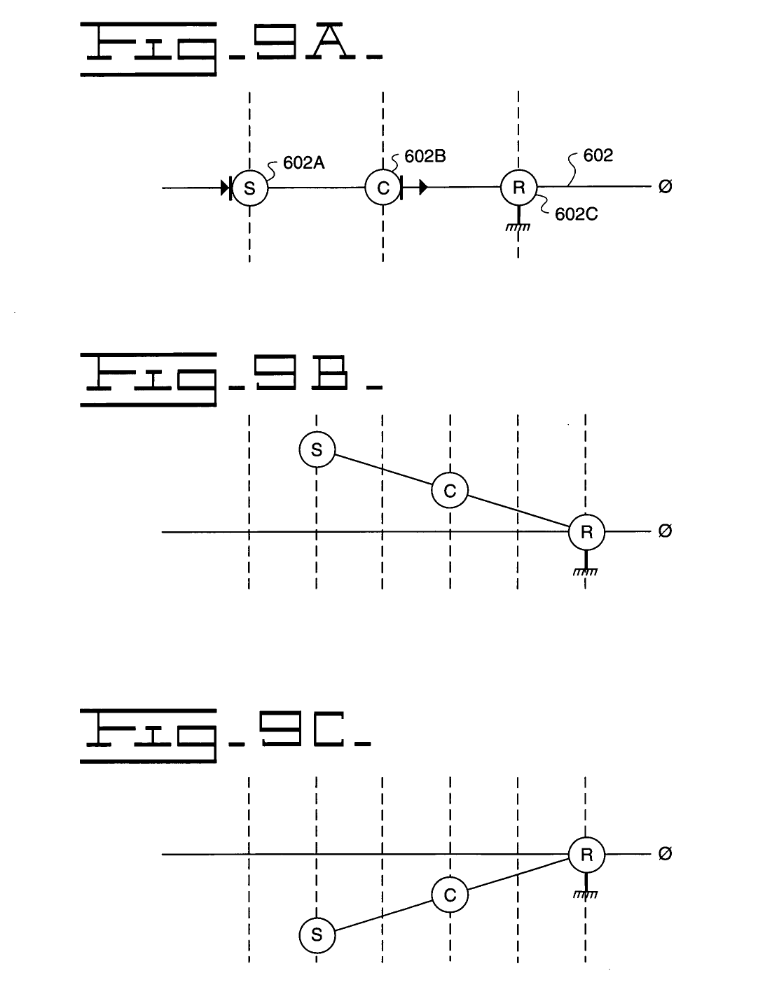

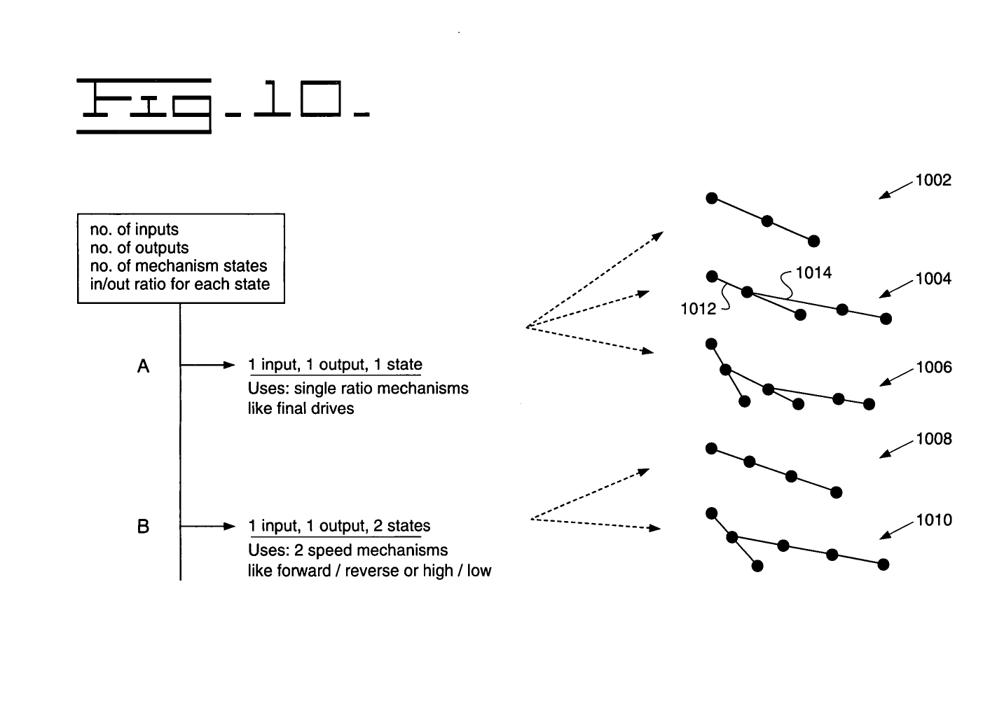

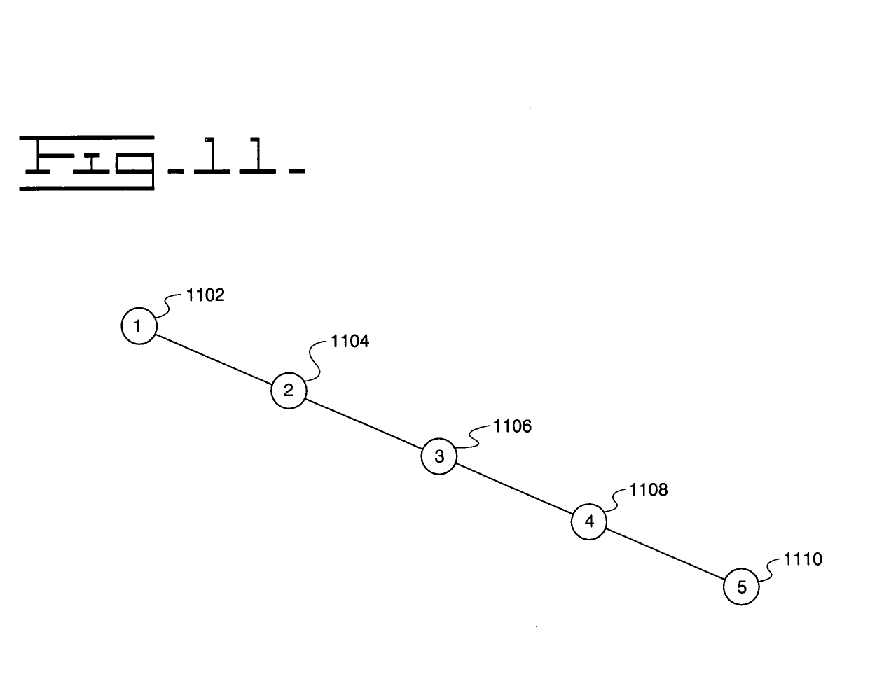

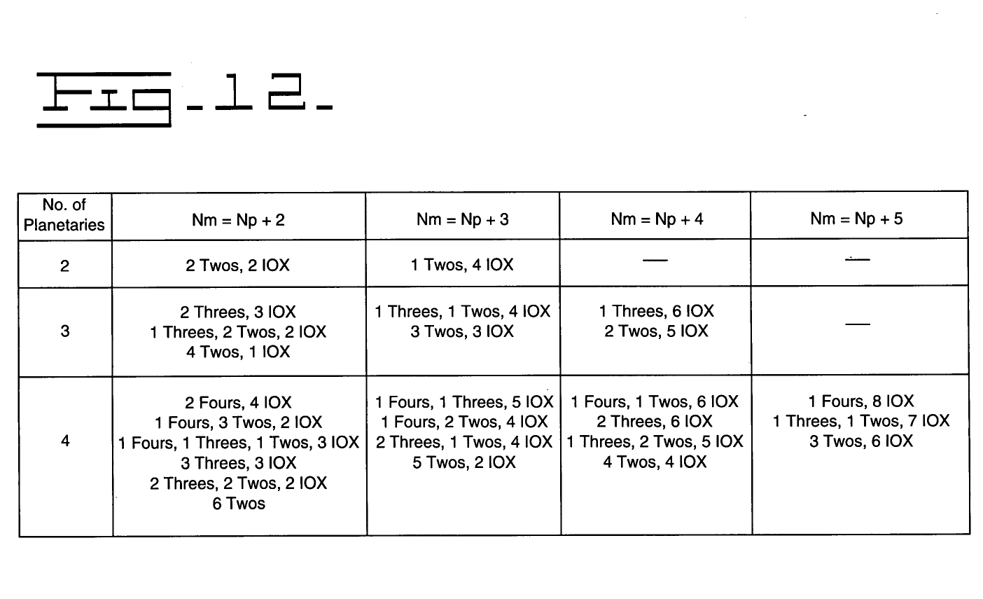

FIG. 1 illustrates an exemplary configuration of elements of a powertrain. The illustrated gear elements include a sun gear 102, multiple planetary gears 104a, 104b, 104c, a ring gear 106, and a carrier 108 associated with the planetary gears 104a, 104b, 104c. The planetary elements 104a, 104b, 104c may be attached to a carrier 108. The gear elements illustrated in FIG. 1, form a planetary gear set 100 (i.e., the sun 102, carrier 108 and ring gear 106). In this example, the planetary gear set 100 may also be referred to as a mechanism 100. A mechanism may include multiple planetary gear sets configured with each other. As will be discussed, the actual gear element configuration and associated mechanism are implementation dependent. The gear elements illustrated in FIG. 1 are for exemplary purposes only. For this example, assume the sun gear 102 is connected to, and driven by a shaft 110, e.g., a drive train from an engine (not shown), and that the carrier 108 is connected to, and drives one or more axels 112. Therefore, the sun gear 102 is receiving the input, and the carrier 108 is providing the output. If the ring gear 106 is stopped, e.g., a clutch is applied to it, the ring gear may be considered grounded. However, the configuration of which gears receive inputs, provide outputs, and/or are grounded is implementation dependent. FIG. 2 illustrates an exemplary schematic representation of the gear elements illustrated in FIG. 1, where “s” denotes sun, “c” denotes carrier, and “r” denotes ring.

FIG. 3 illustrates one embodiment of a system 302 configured to analyze a powertrain having a plurality of gear elements. The system comprises a processor 304 configured to establish a powertrain characteristic associated with the gear elements, establish a mechanism associated with the powertrain characteristic and analyze the mechanism in response to the powertrain characteristic. In one embodiment, the system 302 may include a display 306 configured to display characteristics associated with the analysis. In addition, the system 302 may include a repository 308 (e.g., a memory device) for storing information and/or one or more tables associated with the analysis, as will be described. In one embodiment, the system 302 may include a user interface 310 that enables the user to interact with the system 302 in order to establish the powertrain characteristics, mechanism, and/or associated analysis.

FIG. 4 illustrates a flow diagram associated with one embodiment of a method of analyzing a powertrain having a plurality of gear elements. In a first control block 402, at least one powertrain characteristic associated with the gear elements is established. A powertrain characteristic may include characteristics that are related, directly or indirectly, to one or more of the gear elements. For example, the powertrain characteristic may relate to the size, number, configuration, and hook-up of the elements used in the planetary gear set(s) of the powertrain. Examples of powertrain characteristics may include: desired power reduction between the input source (e.g., engine) and the output source (e.g., wheel or axel), desired speed reduction between the input source and an output source, a desired gear ratio associated with the gear elements and/or the transmission gears, the desired gear element diameter, and/or the desired number of teeth associated with one or more of the gear elements. The powertrain characteristics may be established in several ways. In one embodiment, a user may enter the powertrain characteristics (e.g., via a user interface 310). For example, user may enter the powertrain characteristic through a user interface 310 in several ways, such as: by manually typing in the characteristic in a data text portion of a display, selecting the characteristic from a pull down window, or graphically illustrating the characteristic in a manner that is described below. In an alternative embodiment, the computer system may be pre-programmed with the powertrain characteristics. For example, the computer system 302 may access a local or remote data file that includes the powertrain characteristics, and/or the system 302 may receive information associated with the powertrain characteristics from an actual powertrain configuration (e.g. sensed data etc.). The processor 304 may access a specification or requirements file, and establish one or more powertrain requirements based on information included in the file.

In a second control block 404, a mechanism associated with the powertrain characteristic may be established. The mechanism may be manually or automatically established. In one embodiment of the present invention, the mechanism may be graphically established, as will be described below. FIG. 5 illustrates a display associated with a user interface 310 that will enable the user to graphically establish a mechanism.

The user interface 310 may include three general areas, a tool bar 560, a construction area 562, and a data area 564. The data area 564 is optional. The tool bar 562 may include one or more buttons to construct and analyze a graphical representation of the gear-train mechanism. The user interface 310 may also include a nomograph. The tool bar buttons may include:

Member creation 502, enables the creation of a member on the graph.

Member instantiation 504, enables the instantiation of a created member for a two-member configuration.

Member instantiation 506, enables the instantiation of a created member for a planetary gear set.

Speed lock 510, enables the locking of any gear member, so that it will not move.

Move object 512, enables an object to be moved.

Display zoom 516, 518, enables the zooming in and out of the display.

Print Screen 526, enables the user to print the screen.

Print File 528, enables the user to print the documents associated with the file.

Sketch option 534 enables the user to graphically configure the gear element configuration.

Instantiate Left Input 536, enables the designation of an element as receiving an input, to be represented by an arrow pointing left to right.

Instantiate Right Input 538, enables the designation of an element as receiving an input, to be represented by an arrow pointing right to left.

Instantiate Left Output 540, enables the designation of an element as delivering an output, to be represented by an arrow pointing left to right.

Instantiate Right Output 542, enables the designation of an element as delivering an output, to be represented by an arrow pointing right to left.

Instantiate Radial Input 544, enables the designation of an element as receiving a radial input.

Instantiate Radial Output 546, enables the designation of an element as delivering a radial output.

Grounded Clutch 548, instantiates an element as a grounded clutch.

Ground 550, instantiates an element as being grounded.

Erase 552, enables the erasure of location information.

Find Hookup 554, enables the system to establish hookups associated with the configuration.

Hookup Viewer 556, displays the established hookups.

Manual Hookup 558, enables the user to manually hookup the configuration.

FIG. 6 illustrates one embodiment of a graphical representation of the gear mechanism 102, having three members, which in this example is comprised of one planetary gear set. A member is a collection of one or more gear elements that are connected. That is, as will be illustrated later in a more complex configuration, a member may be used to illustrate the connection between a sun gear of one gear set, and a carrier of a second gear set. In one embodiment, in order to establish a graphical representation, a user may activate the member creation button 504 and create three members 602a, 602b, 602c. The user may designate the particular members as the sun 602a, carrier 602b, and ring gear 602c. The designations may appear as a letter within the member. The user may create connection line 604 among the members that creates a simulated planetary connection among the members using planetary connection tool 508. The user may also graphically designate the inputs, outputs and/or ground of the mechanism. In this particular example, the sun gear 602A has been designated to receive an input (e.g., via a drive train shaft), the carrier is designated by the user to deliver an output (e.g., to an axle), and the ring gear 602c has been designated to be grounded (e.g., by activating buttons: left input 436, right output 440, and ground 452 respectively, and then activating the associated member). Grounding the ring gear 602c means the ring gear 602c will not be permitted to move. Alternatively, the ring gear may move a nominal amount. A gear may be locked at a given speed, and will then maintain that speed. A gear may be grounded meaning it is locked at a speed of zero. The input, output and ground instantiations are implementation dependent. A zero speed (e.g., zero revolutions per minute) line 606 may be used to graphically illustrate the speed of the members relative to zero. As will be described below, the vertical axis denotes speed of the gear. The higher the member is displayed on the vertical axis, the higher the speed of the gear. For example, in FIG. 6, the sun gear 602A is rotating at a higher speed than the carrier 602B.

FIG. 7 is a further elaboration of a graphical representation of the gear mechanism 102. A user may correlate the established powertrain characteristic with the graphical representation in several ways. For example, if a desired gear ratio(s) has been established, the gear ratio(s) may be manually entered in a text input portion of the display, for example, the data area 506. In one embodiment, the ratio may be entered as e-values (e.g., the ratio of the sun gear to the ring gear). Once the ratios are entered, the members 502A, 502B, 502C, may be adjusted (e.g., horizontally) by the system 310, such that the distance 708, 710 between the illustrated members is proportional to the ratio of the elements. Alternatively, (or in addition) each member may have a vertical line 702, 704, 706 associated with it helping to visually identify the horizontal distance or ratio between the gear members. The user may manually select and move a member closer or further away from another member thereby increasing or decreasing the established ratio with that particular member. For example, reducing the ratio between the sun 602a and the ring 602c may be performed by selecting the sun 602A and moving it to the right (or line 706 associated with the sun). The system 310 will maneuver the sun 602a to the designated position (thereby modifying the ratio between the gears). Upon completion of the modification, or while it is occurring, the sun gear 602a is updated to be on the connection line 712. In one embodiment, the distance between the carrier 602b and the ring 602c is maintained while the sun 602a is being moved. Alternatively the distance between the sun 602a and the carrier 602b may be maintained while the sun 602a is being moved. Either way, the carrier 602b may be manipulated afterwards to readjust the ratios if needed. In one embodiment, the distance between the members may be illustrated on the display. Alternatively, or in addition, the gear ratios may be illustrated on the display, in the data area, or both, as the members are being adjusted. In one embodiment, the number of member teeth, and/or member diameter, may be entered to establish the gear ratios. Alternatively, or in addition, the speed reduction between the gears may be entered in the data area, or manually by adjusting the horizontal position of the members. In either case, entering the information in one area (e.g., data area or display area) will update the information in the other area. In one embodiment, a data file may be accessed to obtain the desired information. Therefore, the desired gear ratios may be entered numerically or graphically.

In one embodiment, a sketch tool may be used to create the representation used in the display area 504. For example, the sketch tool button 434 may be activated to display a screen, as illustrated in FIG. 8. In one embodiment, the sketch tool may be used to design and configure the mechanism graphically by entering numerical information. For example, numerical information may be entered and the system 302 will automatically determine the number of members and appropriate (or potential) gear ratios and display the members accordingly that may be used to satisfy the given characteristics.

In one embodiment, the graphical representation of the mechanism may be established first, and then the ratios established. Alternatively the ratios may be established first and then the graphical representation established in response to the ratios.

In a third control block 406, the gear mechanism may be analyzed in response to the powertrain characteristics. In one embodiment, analysis will include graphically simulating the interaction of the gear members and/or gear elements. Using the mechanism illustrated in FIG. 7, if the ring gear 602 is grounded, or locked (i.e., not permitted to move), then the relationship of the sun gear 602a to carrier 602b to ring gear 602c may be simulated by moving the sun gear 602a upwards vertically (indicating an increase in revolutions per minute), and seeing the carrier 602b move vertically a proportional amount. That is, as the sun gear 602a increases in revolutions per minute, the carrier 602b also increases in speed by a proportional amount. Since the ring gear 602c is grounded, in this example, the ring gear 602c remains at zero revolutions per minute. Moving the sun gear 602a downwards will also move the carrier 602b downwards (indicating a decrease in revolutions per second, or a increase in revolutions per second in an opposite direction when the value is negative) by a proportionate amount. Therefore, if the gear mechanism is at rest, it may be illustrated by lying on the horizontal line 606 of zero (0) revolutions per minute, as illustrated in FIG. 9A. Assume the ring to sun gear ratio is 4:1, e.g., the ring gear has 80 teeth and the sun gear has 20 teeth. Therefore, in one embodiment, the linear distance between the ring gear and carrier may be established to be 1, and the distance between the carrier 602B and sun gear 602A may be established to be 4. As the sun increases in speed (rises on the vertical axis), the carrier 602B also increases in speed (rises on the vertical axis), but by a proportional amount, as illustrated in FIG. 9B. As the sun 602 decreases in speed (lowers on the vertical axis), the carrier 604 also lowers in speed (lowers on the vertical axis), but by a proportional amount, as illustrated in FIG. 9c. Therefore the simulation illustrates relative motion/speed of the gear elements.

The simulation may also include speed ranges. For example, the speed range for the gear mechanism may be established to be +2600 rpm to −2600 rpm. The speed range established is implementation dependent. The viewing area associated with the graphical representation may be configured appropriately to view the graphical representation as the gear members move through the speed range. The top of the viewing area may be considered to be +2600 rpm, and the bottom to be −2600 rpm. In this manner, the simulation of the gear members may be displayed as the gear members move through the full speed range. For example, as the sun 602A moves up the vertical axis, manually, or in an automated manner, a calculation may be performed to determine the speed of the sun 602A by dividing the distance above the zero line with the total distance between the zero line and the maximum speed range, and then multiplying the value by the maximum speed. The speed value is also displayed in the data area of the display. In this manner the speed of the sun gear may be determined based upon the movement of the sun gear. Other methods of determining the speed of the sun gear based on its graphical location are also available. The speed of the carrier 602B may be determined in response to the speed of the sun 602A, and vice versa. Therefore, in one embodiment, a user may manually stimulate the simulation. For example, the user may select the move object button 512, and highlight a member (e.g., sun 602A, carrier 602B, or ring 602C), and then move the member along the vertical axis (in both directions). The other members of the gear member configuration will move proportionally, in response to the movement of the selected member. In this manner, the gear member configuration may be manually simulated. In the example provided in FIG. 7, the ring 602C is locked to ground by button 510. Therefore, attempting to move the ring 602C will be unsuccessful, i.e., the ring will not move, nor will any of the other gear members since the ring speed remains at zero. Alternatively, the member location may be modified in an automated manner, either based on the speed of the gear member, or location of the gear member on the display.

In one embodiment, the system 302 will designate one or more members to lock automatically. For example, if no member is locked, and the user maneuvers the sun gear 602a, the system 310 will select another member and lock the member at its current location. Depending on the analysis being performed, having no member locked may not correlate with the desired physical implementation. Therefore the system 302 will automatically select a member and lock it. In the example illustrated in FIG. 7, if no member was locked, the system 310 may assume the ring gear 606c should be locked, or grounded, and will maneuver the carrier 606b proportionally. The scenario where no members are grounded may be referred to as an under-constrained configuration. In one embodiment, if the user has over constrained the mechanism, e.g., locked multiple members such that the mechanism cannot be moved, the system may notify the user that the mechanism is over constrained and request the user to unlock a member. Alternatively the system 302 may automatically select a member to unlock, and then begin the simulation.

In one embodiment, the system 302 may simulate the gear member interaction in an automated manner. An automated manner may include full automation, or automation with some user interaction. That is, once the gear member configuration is assembled or established (either manually or automatically), the user may select a simulate button (not shown). The system will then select an unlocked gear member and begin moving the member through the members available speed range, and displaying the movement of the member being moved, and the other associated members, as they move through the available speed range. The member selected to be moved is implementation dependent. In one embodiment, the system 310 may select a member having an input associated with it. The simulation may occur by simulating the speed of the input (e.g., the drivetrain of the engine). In any case, as a member is being moved, all the members simulated speeds may be tracked to determine when the maximum speed range has been obtained. In one embodiment, the simulation may involve increasing the speed of a member until it reaches its maximum positive available speed threshold, and then decreasing the speed until the maximum negative available speed threshold is reached, and then repeating the process. In this manner, a user may see the interaction of the gear members as their speeds are simulated through the available speed range.

In one embodiment, the simulation may be driven by a data file, or by pre-programming the processor 302. That is, the user may configure a data file to include the available speed range, and a series of speeds at which to drive the simulation. The speeds may be associated with a particular member receiving an input, e.g., the sun 602A being driven by the drive train. In this manner the processor may access the data file and determine the speed range, and then begin moving the member designated in the file through the speeds that are designated in the file.

In another embodiment, the graphical representation may be connected to another simulation program. For example, there may be an engine simulation program that simulates the operation of the engine through the different transmission gears and associated speed ranges (e.g., first, second, third, and reverse gear). One output of the engine speed simulation may be a drive shaft speed. The graphical representation may be configured to receive the drive shaft speed, and responsively stimulate the sun gear 602A of the simulation. In this manner the user may simulate the interactions of the gear members as the gear actions are correlated to engine and transmission operation.

In one embodiment, the graphical representation may be configured to receive actual sensed values from an engine, or an actual gear member configuration. In this manner, the actual interaction of the gear members may be graphically represented. This embodiment will be further discussed below.

Referring again to FIG. 6, other gear members could have been locked instead of the ring gear 602c. For example, the carrier 602b may be locked instead of the ring 602c.

The gear member configuration illustrated in FIG. 9 was used for ease of explaining the disclosure. Any gear member configuration may be assembled and simulated using the present invention. For example, FIG. 10 illustrates some additional gear member configurations that may be graphically represented and analyzed. Configurations 1004, 1006, and 1010 represent multiple planetary configurations being interconnected. Other configurations such as three and four speed mechanisms etc., differential steering mechanisms, hystat mechanisms, and split torque mechanisms may also be graphically represented and simulated using the present invention.

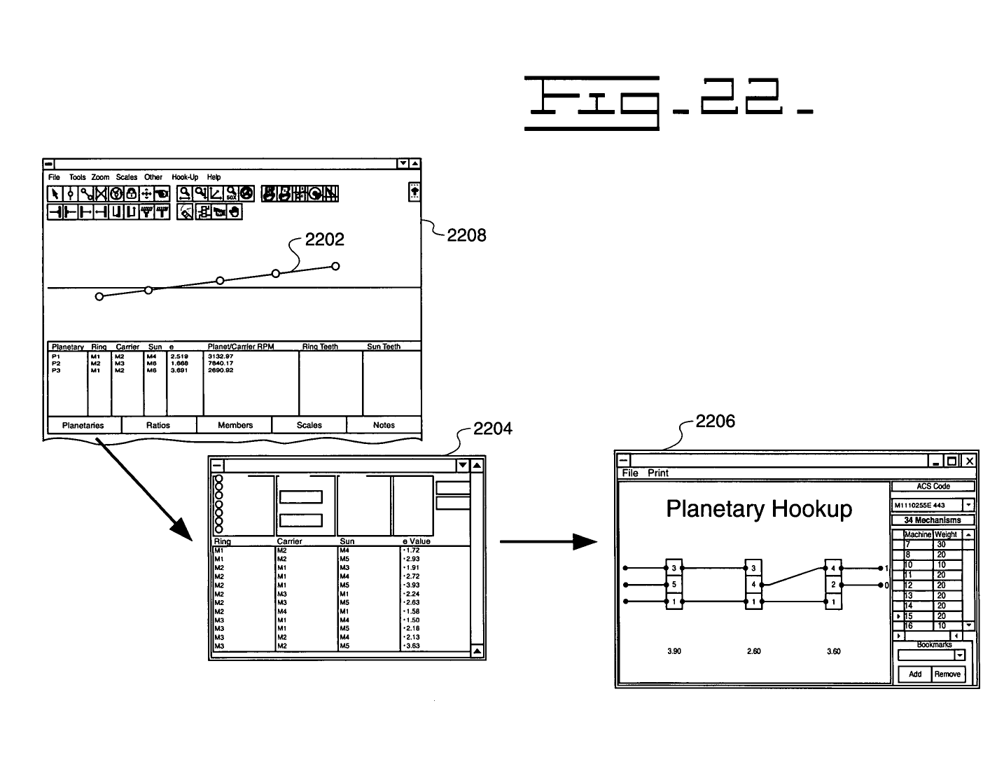

In one embodiment of the present invention, analysis of the gear mechanism may include establishing one or more potential planetary configurations associated with the mechanism. That is, for the mechanism illustrated in FIG. 11, there are many different gear configurations (e.g., number of planetary gear sets used, element connections used, gear ratios etc.) that may be used to configure the desired mechanism. In one embodiment, the system 302 may automatically develop a potential planetary configuration(s) from the powertrain characteristics. As will be discussed, the automatically generated configurations may be available for the user to view. For example, FIG. 20 illustrates a display where the user may scroll down the list of potential configurations and view the schematic representation of the configuration and associated characteristics. The exemplary gear member mechanism illustrated in FIG. 11 will be used to explain establishing a gear member hook-up or configuration. FIG. 11 illustrates one representation of a two speed mechanism. In one embodiment, each potential mechanism associated with the member configuration associated with FIG. 11 will be established and analyzed.

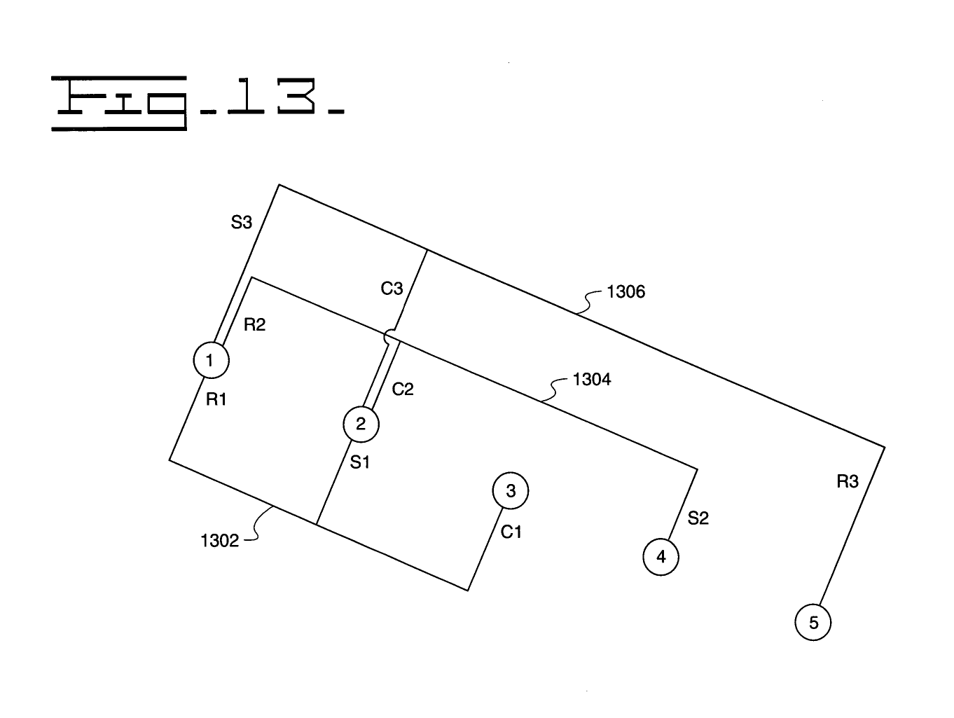

In one embodiment, the user may establish the number of planetary gear sets used to achieve the mechanism illustrated in FIG. 11. Alternatively the system 302, may analyze all the possible configurations using the possible number of gear sets. For example, FIG. 12 illustrates a table showing the connection complexities based on the number of planetary gears sets and the number of members. For a five-member mechanism, either two or three planetary gear sets may be used.

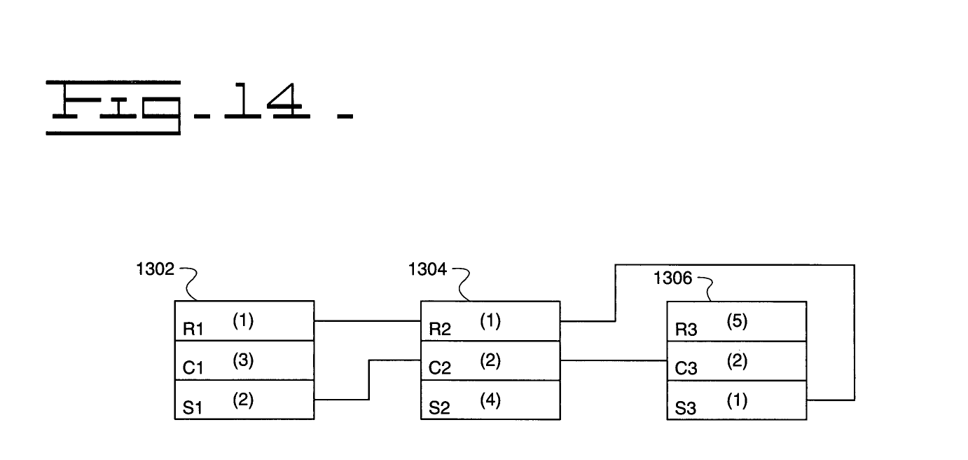

In one embodiment, the ring-carrier-sun potential member assignments the planetary gear(s) of the mechanism may be established. For example, given a set of n members in the mechanism with respective speeds and/or member ratios the system 302 may generate, Ring-Carrier-Sun combinations to form all possible connections between elements of the planetary gear sets. The combination of the elements of planetary gear sets and the members, and the combinations of potential planetary configurations, are combined to establish the potential mechanisms associated with the member. The identified planetary gear set configuration may then be filtered to remove undesired configurations such as configurations having interfering connections (i.e., connections that cannot physically be achieved). The number of ring-carrier-sun combinations (or assignments of an element and a member) that may be established in this example is n*(n-1)*(n-2) (or 60). Examples of planetary gear set combinations include: Ring-Carrier-Sun assignments of (relative to the member reference number) 1m2m3m, 1m2m4m, 1m2m5m, 2m3m4m etc. That is, one possible planetary gear set 1302 (illustrated in FIG. 13) includes the Ring (R1) being assigned to member 1, the Carrier (C1) to member 3, the Sun (S1) to member 2. Another possible planetary gear set 1304 assigns the Ring (R2) to member 1, the carrier (C2) to member 2, and the Sun (S2) to member 4 etc. In one embodiment, no planetary gear set will have the same member listed twice (e.g., 2m2m3m is not a possibility because it would mean the Ring and Carrier of one gear set were connected together).

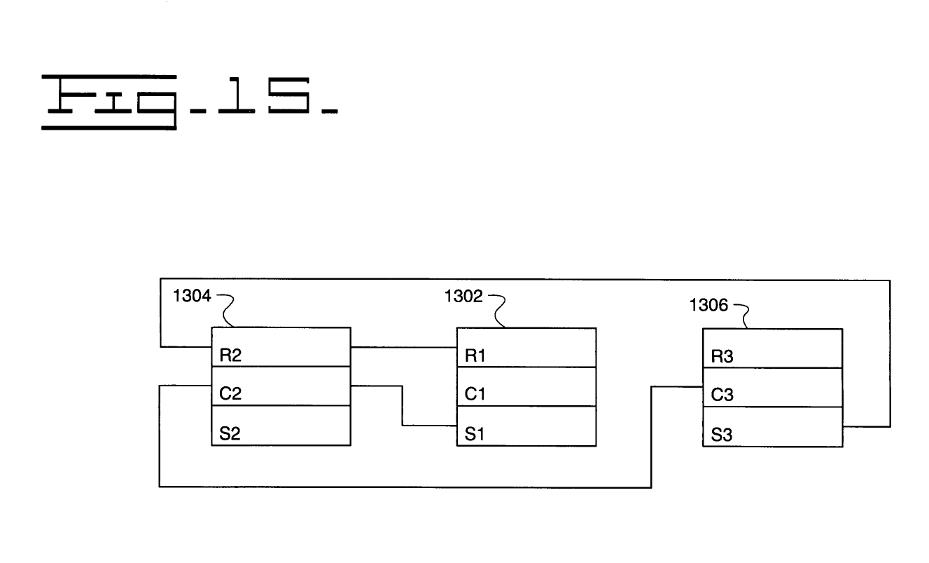

The ring-carrier-sun combinations may be combined to form different mechanism implementations having the number of potential planetaries. For example, the mechanism illustrated in FIG. 11 may be comprised of two or three planetary gear sets. Therefore one possible planetary configuration may be 1m2m3m:3m4m5m. The designation 1m2m3m:3m4m5m means that there are two planetary gear sets (1m2m3m, and 3m4m5m), the first having a Ring assigned to member 1, a carrier assigned to member 2, a sun assigned to member 3. The second gear set has a ring connected to member 3, a carrier to member 4, and a sun to member 5. Another possible configuration may be 1m3m2m, 1m2m4m, 5m2m1m. These combinations may be formed such that all of the members are represented at least once in a mechanism. FIG. 14 illustrates one potential configuration having assignments of three gear sets, where the elements of the first planetary gear set 1302 (R1, C1, S1) are assigned to the members 132 respectively, the elements of the second planetary gear set 1304 (R2, C2, S2) are assigned to the members 124 respectively, and the elements of the third planetary gear set 1306 (R3, C3, S3) are assigned to the members 521 respectively.

Using the above approach, each potential planetary configuration may be established and each possible element assignment may be established, and each combination of elements among planetaries may be established. Additional potential configurations may be obtained by inverting the planetary configurations. That is, the order of the planetary gear sets may be rearranged in the potential mechanism. The number of position inversions for a given mechanism composed of p planetaries may be given by the relation p!. One example of an inversion is:

| | |
|---|---|
| Configuration A: | 231,421,125 |
| Inversion of A: | 421,231,125, etc. |

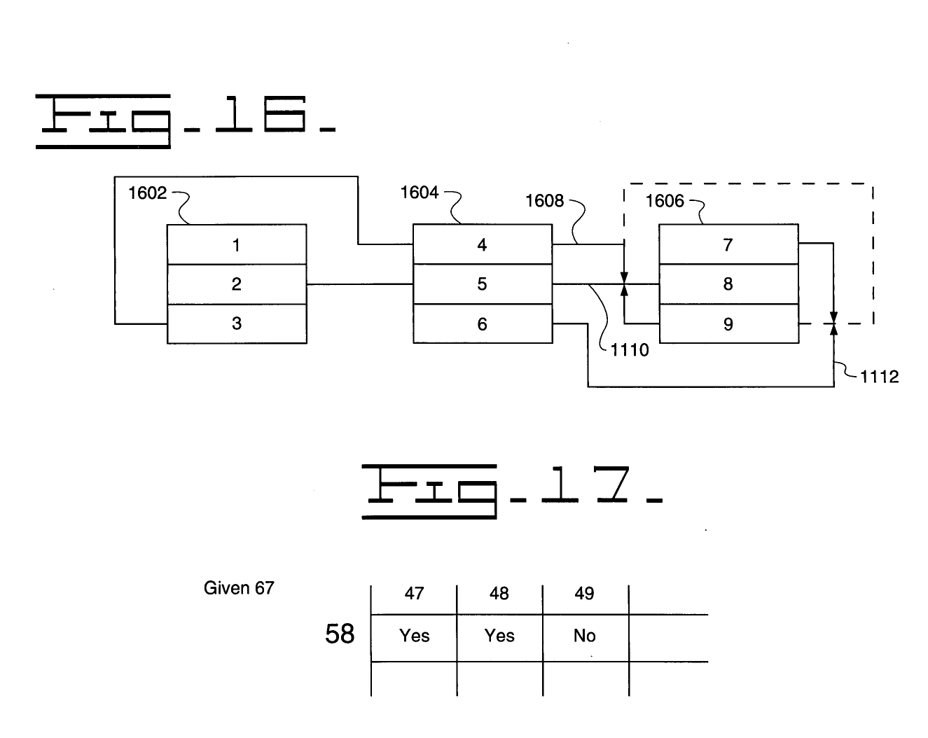

For example, FIG. 14 illustrates a planetary arrangement of Planetary 1 (1302), Planetary 2 (1304), and Planetary 3 (1306) (i.e., 132:124:521). There may also be the possibility of ordering the planetary configurations as Planetary 2 (1304), Planetary 1 (1302), and Planetary 3 (1306) (124:132:521) (illustrated in FIG. 15).

In one embodiment, the bounds connections of the mechanism may be established (or assigned) if they have not been already. Bounds connections include assigning the member(s) that receive inputs, deliver outputs, are grounded, or are potentially grounded. In one embodiment, single elements (elements that are not attached to other elements) may be assumed to be clutched to ground.

In one embodiment, templates are generated associated with all the possible ways in which connections may be accomplished between elements of planetaries in a mechanism. For example, a template associated with the mechanism illustrated in FIG. 14 may be: 149, 358, 2IOX, 6IOX, 5IOX, where IOX represents an element that is grounded, and where combinations of elements (e.g., 149), may be connected with no bounds connection, connected as an input, connected as an output, or may be grounded.

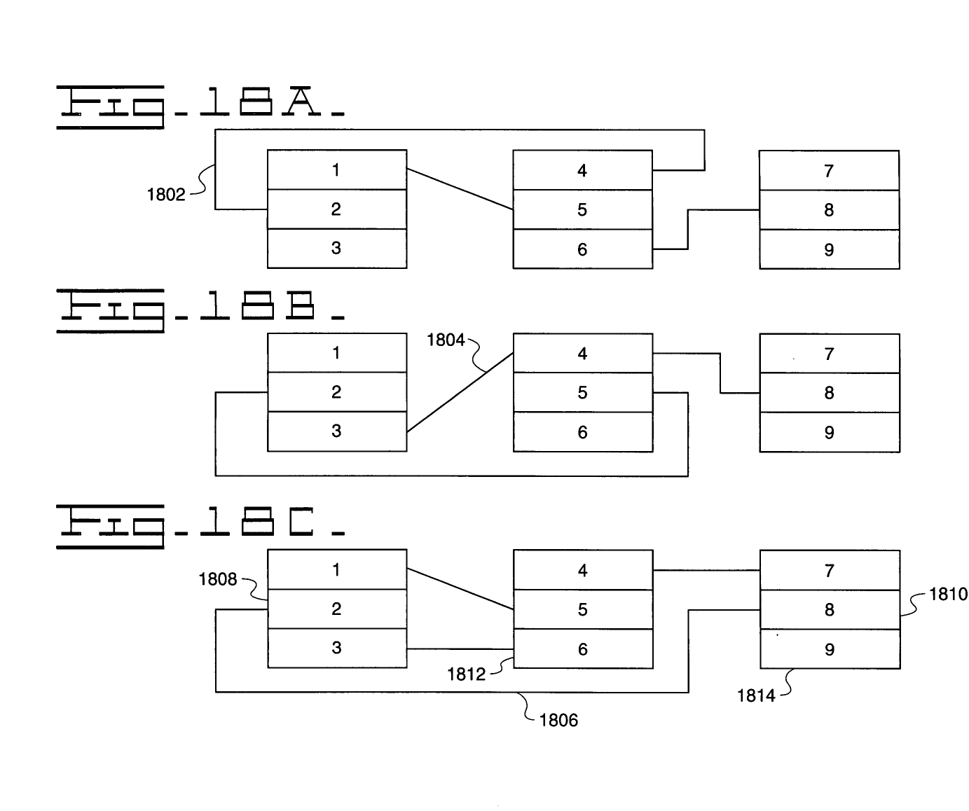

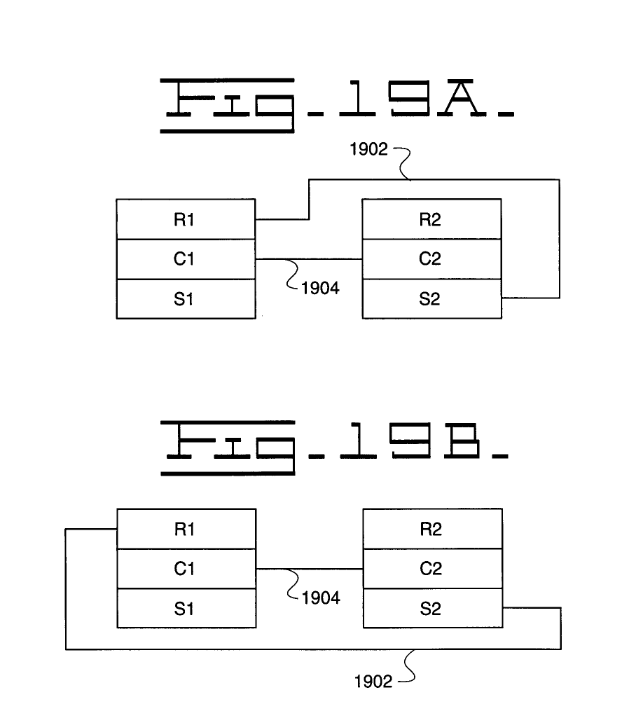

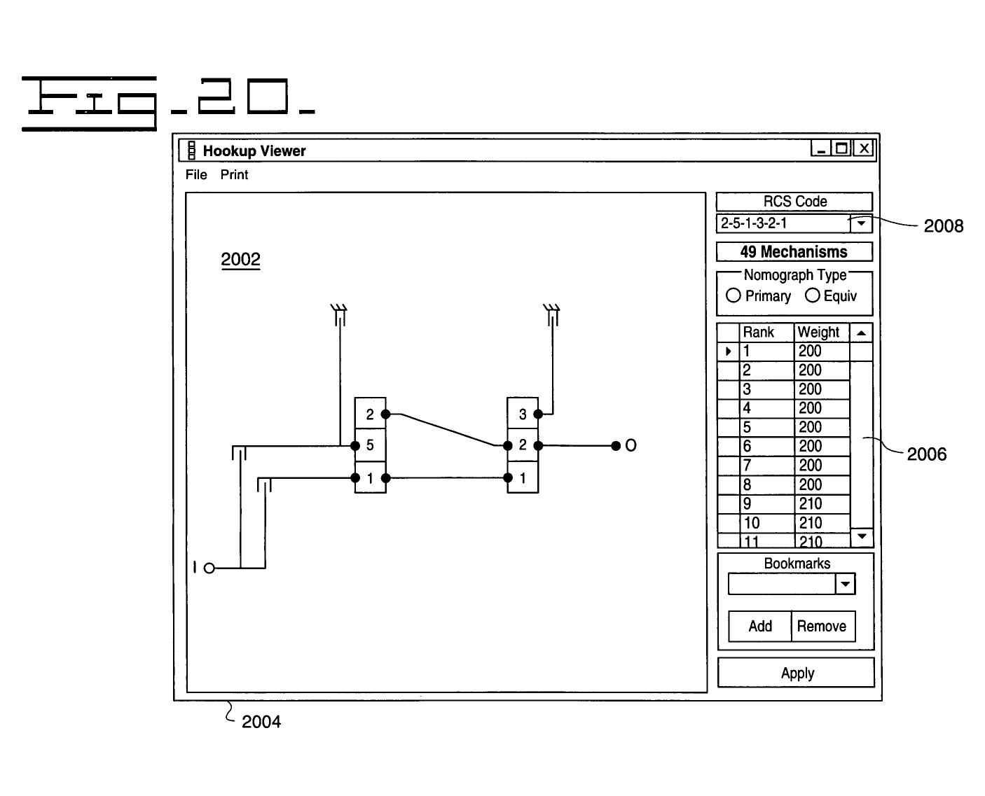

In one embodiment, a collision table may be generated of all possible connections among elements. The collision table provides a guide as to which connections are invalid because they would result in a connection collision. For example, the mechanism illustrated in FIG. 16, would be considered invalid because a connection 1608 between the ring of the planetary 1604 with sun of the planetary 1606 would cause a collision with either the connection 1110 between the carriers of planetary 1604 and planetary 1602, or the connection 1112 between the sun of planetary 1604 and the ring of planetary 1606. FIG. 17 illustrates a portion of the collision table associated with the mechanism of FIG. 16. The collision table may be a multi-dimensional table representing all possible combinations. Therefore, if the path 67 (connection 1112) is connected, the system 302 may loop through the table to establish what configurations are possible. If path 58 (connection 1110) is connected, then path 47 (not shown) may be connected, path 48 (not shown) may be connected, but path 49 (connection 1008) may not be connected. Therefore there is a collision, and the configuration 67, 58, 49 is not permitted. The collision table may also account for the type of connection. For example, connection 1802 (illustrated in FIG. 18A), is an over connection, connection 1804 (illustrated in FIG. 18B) is a between connection, and connection 1806 (illustrated in FIG. 18B) is an under connection. These types of connections may be accounted for in the collision table. As will be discussed, during the selection of a preferred configuration, weighting may be given to the type of connection being made.

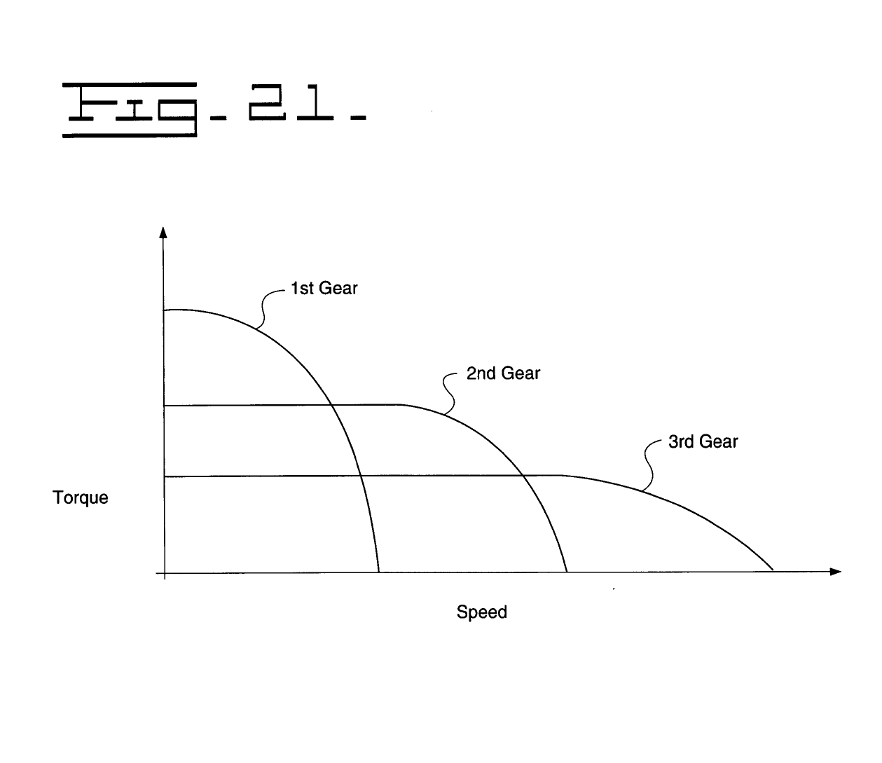

Therefore, in one embodiment, the process of establishing potential valid configurations includes the steps of: establishing the number of planetary gear sets that may be used, establishing the member to ring-carrier-sun assignments for the gear sets, establish the inversions associated with the gear sets, establishing potential state assignments for the elements, establishing templates based on the possible combinations, comparing the templates with the collision table (which may be pre-determined and stored, or dynamically determined). In this manner the possible valid configurations may be established. In one embodiment, the redundant hookups may be eliminated. FIG. 19 illustrates a redundant hookup. A redundant hookup may be described as two hookups identical in all respects except with a bounds connection (1902, 1904) going over in one hookup, and under in another. In one embodiment, these valid configurations may then be prioritized based on the configuration. For example, over and under connections are more complex connections to physically implement than between connections and therefore less desirable. Therefore, in one embodiment, the hookup with the least number of bends, nested paths, over and under connections is considered a desired hookup and may be prioritized as the best. In addition, the configurations may be prioritized based on e-values.

Once the valid hookups have been identified, they may be displayed to the user. Alternatively, all potential hookups may be displayed to the user, or listed so that the user may select and view any particular configuration they desire. In one embodiment, the hookups may be prioritized for the user. FIG. 20 illustrates one embodiment of a user interface 2002 configured to display a hookup to the user. The display may illustrate the “e” values for each of the planetaries. In addition, the user may select which of the hookups they would like to view through the hookup selection portion 2006 of the user interface 2002. The user interface 2002 may also include a display portion 2008 for the ring-carrier-sun codes, and a data entry box 2010 for entering or removing mechanisms from the hookup list. The user may also return to the main display through the return button 2012.

Industrial Applicability

The present invention includes a method and system configured to analyze a powertrain having a plurality of gear elements. The method includes the step of establishing a powertrain characteristic associated with the gear members, establishing a mechanism in response to the powertrain characteristic, and analyzing the mechanism in response to the powertrain characteristic.

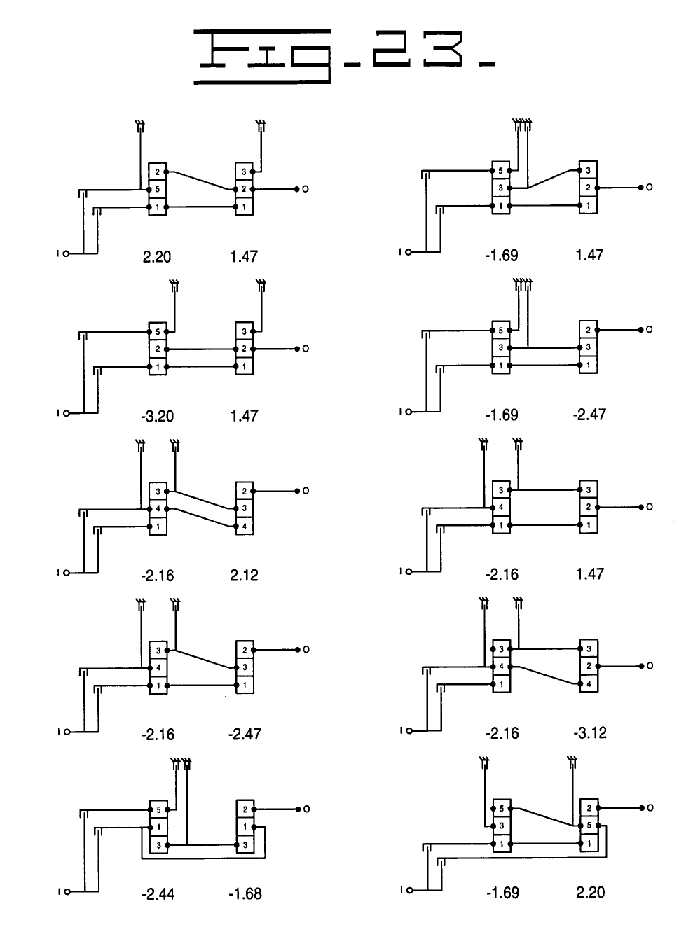

In one example, there may be a need to design a powertrain for a tracked vehicle, e.g., a bulldozer, track type tractor etc. A designer may desire the machine have three forward transmission gears, and the associated torque/speed ranges as illustrated in FIG. 21. The designer may determine that the engine produces 300 foot-pounds of torque at 1800 revolutions per minute. The designer may also know how much torque and speed they want delivered to the tracks, and at what gears they want this torque. Therefore, they may determine an overall desired speed or torque ratio from the engine to the tracks (e.g., 100:1).

In one embodiment, the powertrain characteristic (e.g., 100:1 speed or torque ratio) may be used to design the powertrain. For example, a designer may enter the desired speed reductions, and the desired number of transmission gears (e.g., three forward gears). The system 302 may then establish a mechanism in response to the input and then analyze the mechanism. For example, the system may establish all possible planetary gear configurations that satisfy the mechanism and rank the configurations accordingly. For example, based on the speed reduction, the system 302 may try mechanisms with one, two, or three planetary gear sets, and then determine configurations of the gear sets, and associated hookups. The system 302 may analyze the potential configurations and make a recommendation, or provide the user with a list of the possibilities and enable the user to select the configuration preferred.

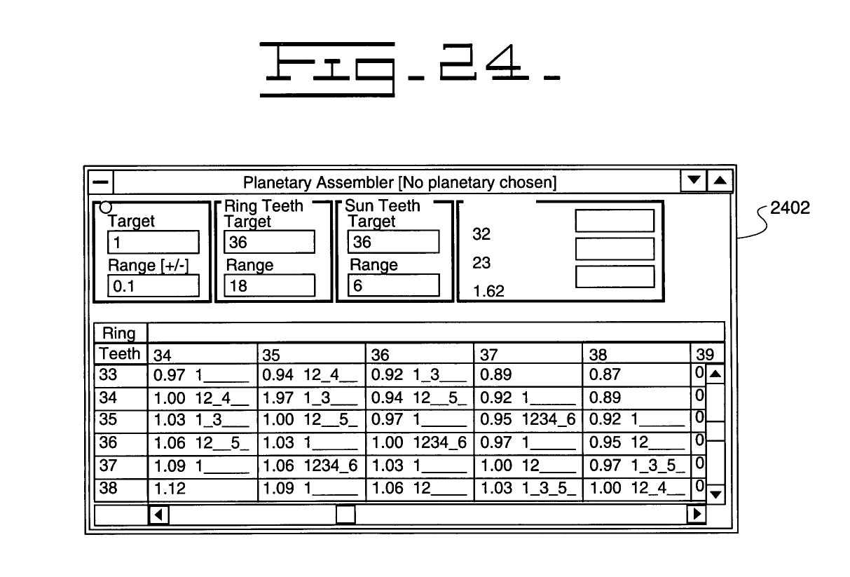

In an alternative embodiment, the user may manually graphically create a mechanism with a single planetary gear set, as illustrated in FIG. 7. The user may manipulate the location of the graphical members to provide the desired gear ratios. As the user does this, the e-ratio will be displayed at the bottom of the display (the display area 606). The user will realize that one planetary gear set is not desirable because of the size of the gears needed to obtain the ratio. Therefore, the user may enter a mechanism comprised of multiple planetary gear sets, as illustrated in FIG. 22. The system may enable the user to graphically create a potential mechanism 2202, then select potentially desirable ring carrier sun ratios using the RCS display 2204 (e.g., based on user configured e-ranges), and then generate all the possible hookups, from which the user may select, a portion of which are illustrated in FIG. 23. For example, hook-up interface 2206, prioritizes the potential hookups, based on e-values and complexity, and lets the user determine which they desire. In one embodiment, the user may go from the mechanism display 2208, to the hook-up interface 2206 by letting the system 302 determine all possible configurations regardless of e-values.

In one embodiment, the user may have used a powertrain characteristic input interface 2402, as illustrated in FIG. 24. The powertrain characteristic inputs provided, may be used to graphically illustrate one or more mechanisms satisfying the inputs characteristics, and may also be used to determine one or more potential hook-ups that may be used to configure a mechanism meeting the input characteristics.

In one embodiment, the system 302 may be integrated with or used in conjunction with other design tools. For example, there may be an associated gear analysis tool to help prioritize the potential planetary gear configurations based on desired gear ratios/sizes. That is, some configurations may not be desired because the diameter of one of the gears may be so small, and the number of revolutions so high, that a projected gear life analysis may indicate a low gear life, or unreliable performance during the expected life. In addition, the analysis may indicate that the bearings needed to support the proposed gear size or gear ratio is not desired, again to bearing life or reliability issues. Therefore, analysis from a gear life, or gear sizing simulation tool may be integrated into the system 302 to access potential configurations, e.g., used as one of the factors in prioritizing the configurations. In addition, other performance or simulation programs may be integrated with the system 302 to provide a complete system design tool and/or simulation tool.

Other aspects, objects, and advantages of the present invention can be obtained from a study of the drawings, the disclosure, and the claims.

What is claimed is:

1. A computer-based method of analyzing a powertrain having a plurality of gear elements, comprising the steps of:
establishing a powertrain characteristic associated with said gear elements;
establishing a mechanism associated with said powertrain characteristic; and
analyzing said mechanism in response to said powertrain characteristic.

2. A computer-based method, as set forth in claim 1, wherein said mechanism includes a plurality of members, and further wherein the step of analyzing said mechanism further comprises the step of graphically simulating an interaction of said members.

3. A computer-based method, as set forth in claim 1, wherein the step of simulating said interaction further comprises the steps of:
identifying said mechanism is under constrained; and
selecting one of said members to constrain in response to said under constraint.

4. A computer-based method, as set forth in claim 1, further comprising the step of establishing a plurality of planetary configurations in response to said mechanism.

5. A computer-based method, as set forth in claim 4, wherein the step of analyzing said mechanism further comprises the step of recommending one of said planetary configurations.

6. A computer-based method, as set forth in claim 4, wherein the step of establishing said planetary configuration further comprises the step of establishing a potential gear member hook-up associated with said planetary configuration.

7. A computer based method, as set forth in claim 6, wherein the step of establishing a potential gear member hook-up associated with said planetary configuration further comprises the step of establishing a plurality of potential hook-ups associated with each of said plurality of planetary configurations.

8. A computer based method, as set forth in claim 7, further comprising the step of identifying which of said potential planetary configuration has a hook-up collision.

9. A computer-based method, as set forth in claim 1, wherein the step of analyzing said mechanism further comprises the steps of:
receiving sensed inputs associated with a physical powertrain having physical gear members, said physical gear members being associated with said mechanism; and
graphically simulating an interaction of said physical gear members in response to said sensed inputs.

10. A system configured to analyzing a powertrain having a plurality of gear elements, comprising:
a user interface configured to receive a plurality of powertrain characteristics associated with said gear elements;
a controller configured to receive said powertrain characteristics and establish a mechanism associated with said powertrain; and
a display configured to display said mechanism.

11. A system, as set forth in claim 10, wherein said user interface is further configured to graphically receive a user input regarding at least one of a gear ratio, a gear speed, and a gear instantiation; and wherein said controller is configured to either modify said mechanism or create said mechanism in response to said graphical input.

12. A system, as set forth in claim 11, wherein said controller is further configured to graphically display at least one of a powertrain configuration and a powertrain hook-up; and
a controller configured to establishing a mechanism associated with said powertrain characteristic and said gear elements, and analyzing said mechanism in response to said powertrain characteristic.

13. A computer-based method of analyzing a powertrain having a plurality of gear elements, comprising the steps of:
establishing a powertrain characteristic associated with said gear elements;
establishing a plurality of planetary configurations associated with said powertrain characteristic; and
displaying at least one of said plurality of planetary configurations.

14. A computer-based method, as set forth in claim 13, wherein the step of establishing said plurality of planetary configurations further comprises the step of creating a plurality of hook-ups associated with said configurations.
